(19) United States
(12) Patent Application Publication
(10) Pub. No.: US 2010/0050975 A1
(43) Pub. Date: Mar. 4, 2010

(54) METHOD FOR PRODUCING A CAST PART, IN PARTICULAR A PISTON BLANK

(75) Inventors: Peter Everwin, Bad Rappenau (DE); Emmerich Ottliczky, Ernsbach (DE); Walter Braunauer, Untergruppenbach (DE); Michael Winandi, Untereisesheim (DE)

Correspondence Address: YOUNG BASILE, 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 12/307,855

(22) PCT Filed: Jul. 4, 2007
(86) PCT No.: PCT/EP07/05916

§ 371 Date: Oct. 9, 2009

(30) Foreign Application Priority Data
Jul. 5, 2006 (DE) 10 2006 031 088.8

(51) Int. Cl. F02F 3/00; B22D 29/00; F16J 1/00

(52) U.S. Cl. 123/193.6; 164/69.1; 92/172

(57) ABSTRACT

A method for producing a cast part using a casting machine which comprises a least one casting mould that can be filled with a casting melt. According to the method, the casting is filled with a casting melt, the melt is left to completely solidify and the cast part is then removed from the casting. The casting is filled with melt by the casting machine without the use of pressure at a fill speed of less than 10 m per second in the gating and is then squeezed in the casting mould at a casting pressure greater than 100.

### BACKGROUND

The invention relates to a method for producing a cast part and cast part produced under this method.

Methods are known for producing cast parts using a casting machine which has at least one casting mold that can be filled with a casting melt, wherein the casting mold is filled in a variety of ways with casting melt, the melt is let to solidify completely and the cast part is removed from the casting mold. In this respect, references is made to EP 120 649 B1, EP 0 805 725B1, EP 0115 150B1 or EP 0 338 419 B1.

One aspect of the prior art are casting methods that are also called low-pressure casting methods. In these low-pressure casting methods, casting machines are used in which casting pressure is less than 1 bar and the melt speed in the gate is substantially less than 1 meter/second, thus ensuring that the casting mold is filled with a laminar flow of melt. The cast parts produced using a low-pressure casting method are characterized by good material properties, but they suffer from the disadvantage that it takes a relatively long time until the melt has solidified in the casting mold. This is disadvantageous particularly in the series production of cast parts, as for example, pistons for internal combustion engines, since a relatively long time passes including the preparation and post processing.

Besides low-pressure casting methods, there are pressure-casting methods that operate with fill speeds in the gate higher than 10 meters/second and casting pressures far above 100 bar. Satisfactory cast parts can also be produced using these pressure-casting methods. These high-pressure casting methods, however, have the disadvantage that the casting mold if filled at very high flow speeds, with consequent high turbulence. This results in commingling of melt and gases which solidify at high pressure and that still have the disadvantage of defects such as cavities, porosity and oxidic inclusions and thus severely affecting the material properties of the cast part.

It would be desirable to provide an improved method for producing a cast part, wherein the cast parts produced by means of this method are clearly improved with respect to strength and structure compared with those cast parts that have been produced with low-pressure casting methods or with pressure-casting method using the aforementioned parameters

### SUMMARY

A casting melt is introduced from a casting machine into a casting mold without pressure at a fill speed of less than 10 meters/second in the gate and solidifies at far above 100 bar when it is squeezed. This casting method is also termed squeeze casting (abbreviated to SC). It is important that the term squeeze casting used here represents a casting method that is carried out at a fill speed of less than 10 meters/second in the gate and at a casting pressure higher than 100 bar. In the state of the art, casting methods are also identified by the term squeeze casting to which clearly different parameters, machine and tool concepts apply that do not lead to the desired casting results such as are described in what follows.

The squeeze-casting method has the advantage that a qualitatively high-grate cast is created that is free of inclusions and has an extremely fine, homogenous structure. Since the casting mold an, in particular, a pressure-resistant casting core (sand or salt) used therein can be designed in any shape, great design latitude exists that, at the same time, because of the advantageous fill speed and the advantageous casting pressure, goes along with a high cycle sequent and this very short cycle times in series production of cast parts. Production costs can be substantially reduced while retaining the casting quality comparable with the low-pressure method.

### BRIEF DESCRIPTION OF THE DRAWINGS

In the drawing:

FIG. 1 is a chart depicting

FIG. 2 is a graph depicting

FIG. 3 is a cross-section of a mold depicting the present method.

### DETAILED DESCRIPTION

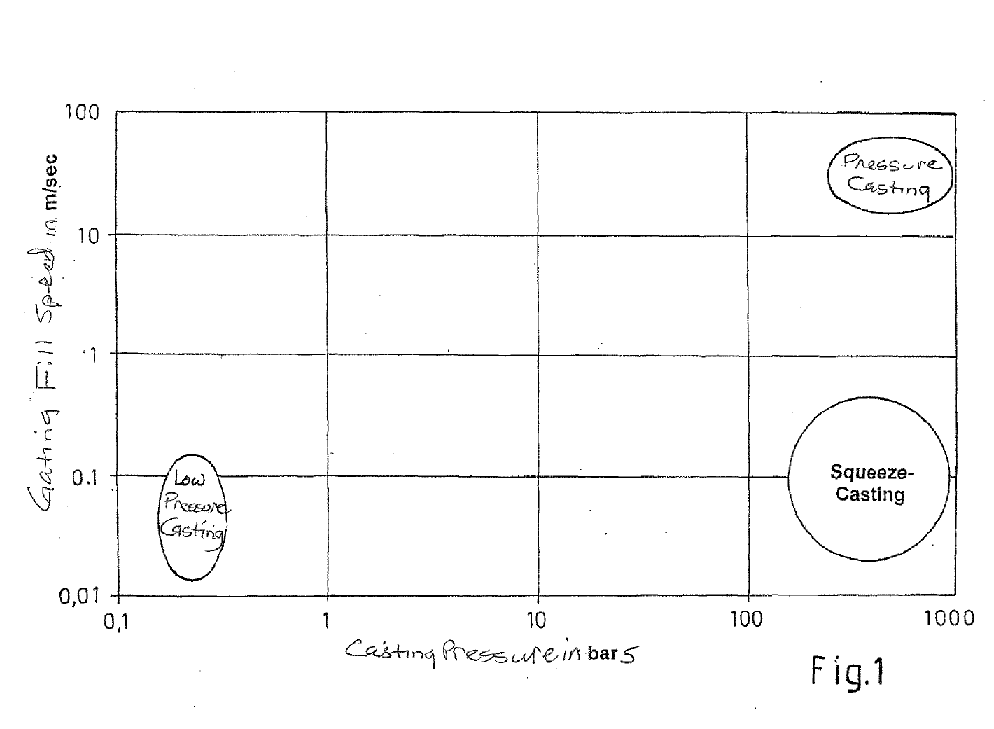

In FIG. 1, process parameters for different cast methods that are known from the prior art (low-pressure casting method and pressure-casting method) are compared with squeeze casting in accordance with the present method.

The low-pressure casting method (ND-Guβ) operates with fill speeds in the gate clearly below one meter/second and casting pressures similarly well below 1 bar.

The pressure-casting method operates with fill speeds in the gate above 10 meters/seconds and casting pressures higher than 100 bar.

It is known that in the ranges between (fill speeds perhaps 0.1 and 10 meters/seconds and casting pressures approximately between 1 and 100 bar, i.e. mixing range with laminar, turbulent filling at pressure that is inadequate for refilling)cast parts can be produced, but such cast parts do not have satisfactory usage properties, which are highly disadvantageous with respect to strength, for example.

In accordance with the present method, squeeze casting is carried out at a fill speed in the gate of less than 10 meters/second, preferably less than 1 meter/second, and a casting pressure higher than 100 bar, preferably higher than 500 bar. As a result of these process parameters, which can be set and carried out by the casting machine the desired material properties, such as structure and mechanical of the cast parts can be achieved, with simultaneous high cycle rates in the production of such cast parts. The process parameters in the prior art, in contrast, cannot be regulated by means of a closed loop, but only controlled.

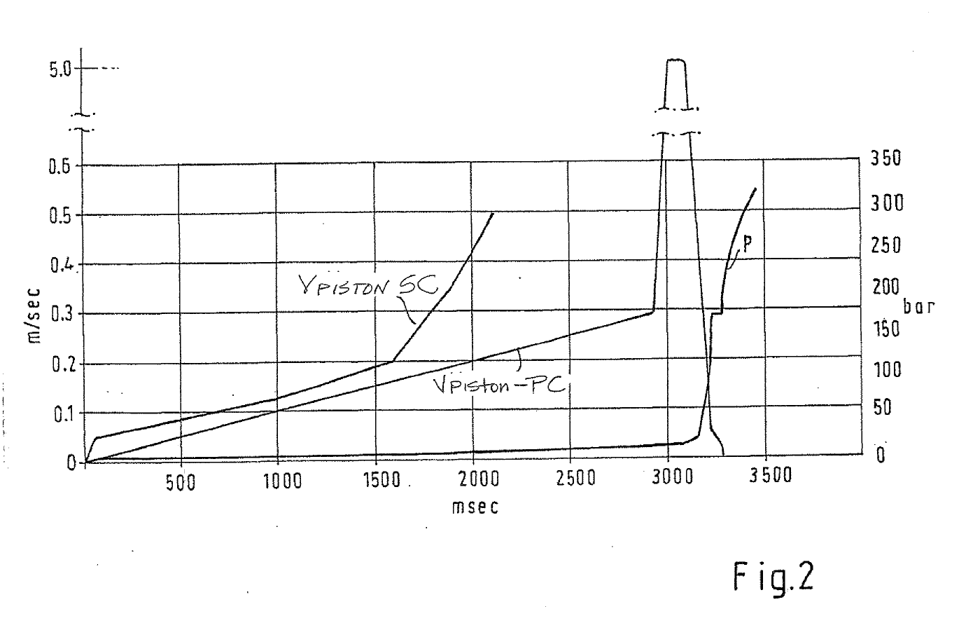

FIG. 2 shows a graph that compares known pressure casting with squeeze casting in accordance with the present method. The time in milliseconds is entered on the x-axis, while the speed of a casting piston of the casting machine is shown on the left y-axis in meters/second. It can be seen that with the pressure-casting method the assumed speed of 5 meters/second with fixed tool gate geometry leads to turbulent filling typical of pressure casting.

In contract, the casting piston speed in the SC method during the filing process is limited to 0.5 meters/second, for example, which ensures laminar mold filling with a clearly enlarged gate geometry.

The pressure curve shown in FIG. 1 (parameter p) schematically shows the identical pressure (curve) at the two casting piston speeds described (V_{Piston SC}, V_{Piston DG}, piston=casting piston of the casting machine).

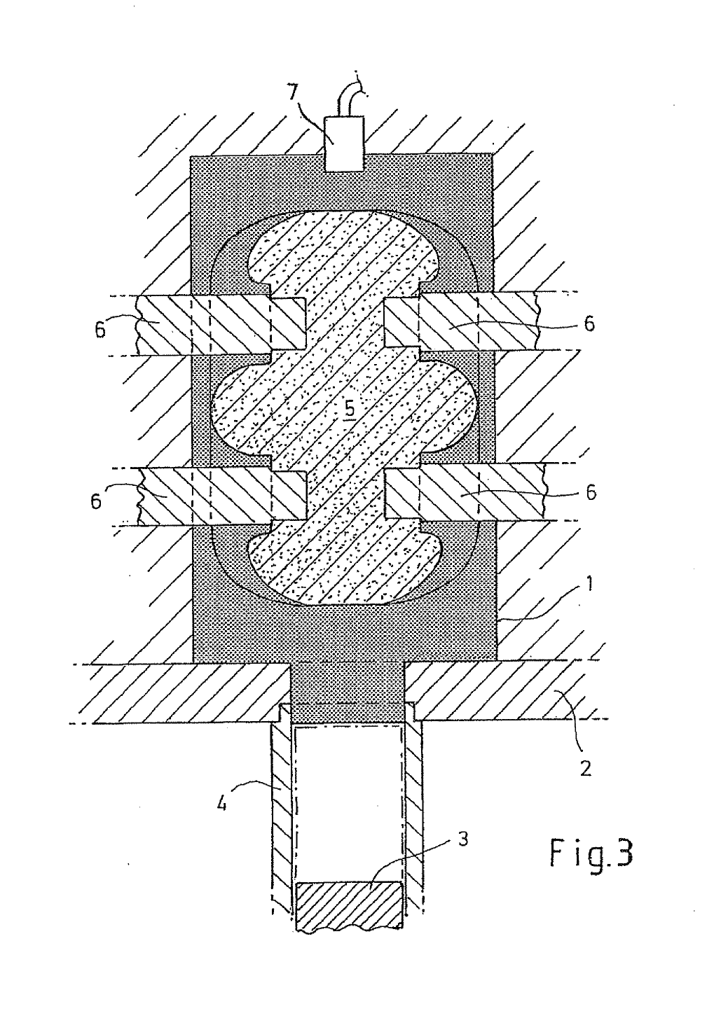

An example of a casting mold that is used in squeeze casting in accordance with the present method is shown is shown FIG. 3.

The casting mold is shaped in such a way that only a single cast part can be produced. For example, for producing piston blanks, the casting mold is shaped such that, following the casting process, the least two piston blanks joined to each other are cast, wherein the finished cast part removed from the casting mold is separated along a part line, for example using a sawing process to produce the two piston blanks that can be provided for further finishing. The cast part does not necessarily have to have only two partial cast parts connected to each other, but can consist of more than one from one mold cavity which are connected to each other following casting by means of the casting system and are then separated from each other.

The casting mold is given the reference numeral 1 and is fastened to a plate 2 of the casting machine (shown here only schematically with a casting piston 3 and a gate 4). The casting mold 1 has a pressure-resistant core 5, a salt core for example, meaning that at least one pressure-resistant casting core is inserted into the casting mold to produce a cavity in the cast part.

If the cast part that is to be produced using the present method is, for example, a piston for an internal combustion engine, the inner contour of the casting mold 1 matches the outer counter of the piston blank to be cast, while the outer contour of the salt core reproduces the inner contour of the piston blank. To realize piston pin bores in the piston, bolts 6 are inserted in the casting mold 1.

It is further more advantageous if the casting mold is evacuated before and/or during the process of filling with the casting melt. The casting mold has a corresponding aperture 7 for this through which the casting gases inside the casting mold 1 can be drawn off using appropriate means.

The work sequent for squeeze casting in accordance with the present method is as follows:

The casting mold 1 is treated with a separating agent, for example, by a spray application. Then the pressure-resistant core 5 (or several cores) is inserted that reproduce matching areas in the cast part (the piston blank). Before or during the filing of the casting mold 1 with casting melt through the gate 4, the casting mold is evacuated through the aperture 7. After the casting mold 1 has been filled with casting melt in accordance with the process parameters described previously, the finished cast part, not identified more closely here, can be removed from the casting mold and the finished cast part can be treated further. The finished cast part is quenched in a water bath, for example, and, at the same time, the core 5 is removed through precast openings, for example, by purging. After the subsequent removal (for example by sawing) of the press residue located in the vicinity of the former gate 4, the single-piece cast part can either be further machined or separated, if single- or multi-piece cast part is separated from multiple casting cavities (as for example piston blanks). Then these parts can be machined further, specifically subjected to heat treatment and brought to final dimension (for example by metal-removing machining).

1. A method for producing a cast part using a casting machined that has at least one casting mold which can be filed with a casting melt, wherein the casting mold is filled with casting melt, the melt is left to solidify completely and then the cast part is removed, the method comprising the steps of the casting mold:
filling by the casting machine without the use of pressure at a fill speed of less than 10 meters/second; and
squeezing the cast melt at a casting pressure higher than 100 bar.

2. The method of claim 1, wherein the fill speed is less than 1 meter/second, and, after the mold filling the casting pressure is higher than 500 bar.

3. The method of claim 1 further comprising the step of:
before filing the casting mold with casting melt, inserting at least one pressure-resistant casting core to produce a cavity in the cast part.

4. The method of claim 1, further comprising the step of:
separating the cast part removed from the casting mold into at least two partial cast parts.

5. The method of claim 1 further comprising the step of:
evacuating the casting mold before and/or during the filing of the mold with casting melt.

6. A cast part manufactured in accordance with the method of claim 1.

7. The cast part of claim 6:
wherein the cast part is a piston blank for a piston in an internal combustion engine.

8. The cast part from claim 6:
wherein the casting mold and the pressure-resistant core are shaped in such a way that at least two piston blanks are cast connected to each other.
